(19) United States
(12) Patent Application Publication
(10) Pub. No.: US 2021/0132375 A1
(43) Pub. Date: May 6, 2021

(54) EYE TRACKING DEVICE AND HEAD MOUNTED DISPLAY

(71) Applicants: Acer Incorporated, New Taipei City (TW); STARVR CORPORATION, NEW TAIPEI CITY (TW)

(72) Inventors: Tsung-Wei Tu, New Taipei City (TW); Wei-Kuo Shih, New Taipei City (TW); Shih-Ting Huang, New Taipei City (TW); Yen-Hsien Li, New Taipei City (TW)

(73) Assignees: Acer Incorporated, New Taipei City (TW); STARVR CORPORATION, NEW TAIPEI CITY (TW)

(21) Appl. No.: 17/083,302

(22) Filed: Oct. 29, 2020

(30) Foreign Application Priority Data
Nov. 6, 2019 (TW) 108140229

(51) Int. Cl. G02B 27/00; F21V 8/00; G02B 27/01

(52) U.S. Cl. CPC G02B 27/0093; G02B 6/0035; G02B 2027/014; G02B 6/0076; G02B 27/0101

(57) ABSTRACT

An eye tracking device including an optical waveguide component, a light source module, and an eye tracking module is provided. The optical waveguide component has a light-entrance surface and a light-exit surface connecting the light-entrance surface. The light-exit surface has a plurality of micro-structures directly formed on the light-exit surface. The light source module is disposed next to the light-entrance surface and adapted to provide a light beam. The light beam enters the optical waveguide component through the light-entrance surface, and the light beam is emitted from the optical waveguide component through the micro-structures and is transmitted to an eye. The eye tracking module receives a portion of the light beam reflected by the eye and determines a location of the eye based on the portion of the light beam reflected by the eye. A head mounted display is also provided.

### CROSS-REFERENCE TO RELATED APPLICATION

This application claims the priority benefit of Taiwan application serial no. 108140229, filed on Nov. 6, 2019. The entirety of the above-mentioned patent application is hereby incorporated by reference herein and made a part of this specification.

### BACKGROUND

### Technical Field

The disclosure relates to a tracking device and a display device, and more particularly, to an eye tracking device and a head mounted display (HMD).

### Description of Related Art

In order to achieve audio and video effects of good quality, virtual reality (VR), augmented reality (AR), and mixed reality (MR) technologies have become one of the research and development priorities of next-generation display technology, and the HMD is one of the means to reduce these technologies to practice.

In general, the HMD tracks a location of an eye through an eye tracking device installed in the HMD and adjusts the displayed image according to an eye gaze direction, so as to improve the VR, AR, or MR effects. The existing eye tracking device mainly adopts a plurality of reflection mirrors to reflect a light beam to the eye, and then determines the location of the eye according to the light beam reflected by the eye. However, said eye tracking device requires more optical components, thus increasing the complexity of the optical components, reducing the process yield, and increasing the size and the weight of the entire eye tracking device. Since the HMD is mounted on the head of a user, the optical components (including the eye tracking device) in the HMD should be light and thin to enhance the user's wearing comfort.

### SUMMARY

The disclosure provides an eye tracking device and an HMD, which are light and thin and have a high process yield.

In an embodiment of the disclosure, an eye tracking device includes an optical waveguide component, a light source module, and an eye tracking module. The optical waveguide component has a light-entrance surface and a light-exit surface connecting the light-entrance surface. The light-exit surface has a plurality of micro-structures directly formed on the light-exit surface. The light source module is disposed next to the light-entrance surface and adapted to provide a light beam. The light beam enters the optical waveguide component through the light-entrance surface, and the light beam is emitted from the optical waveguide component through the micro-structures and is transmitted to an eye. The eye tracking module receives a portion of the light beam reflected by the eye and determines a location of the eye based on the portion of the light beam reflected by the eye.

In an embodiment of the disclosure, an HMD includes an image device and an eye tracking device. The image device includes an image optical waveguide component and an image light source module. The optical waveguide component has a light-entrance surface and a light-exit surface connecting the light-entrance surface. The image light source module is disposed next to the light-entrance surface of the image optical waveguide component and adapted to provide an image beam. The eye tracking device includes an optical waveguide component, a light source module, and an eye tracking module. The optical waveguide component overlaps the image optical waveguide component. The optical waveguide component has a light-entrance surface and a light-exit surface connecting the light-entrance surface, and the light-exit surface of the optical waveguide component has a plurality of micro-structures directly formed on the light-exit surface. The light source module is disposed next to the light-entrance surface of the optical waveguide component and adapted to provide a light beam. The light beam enters the optical waveguide component through the light-entrance surface of the optical waveguide component, and the light beam is emitted from the optical waveguide component through the micro-structures and is transmitted to an eye. The eye tracking module receives a portion of the light beam reflected by the eye and determines a location of the eye based on the portion of the light beam reflected by the eye.

Based on the above, in the eye tracking device and the HMD provided in one or more embodiments of the disclosure, the optical waveguide component guides the light beam to the eye by the micro-structures directly formed on the optical waveguide component. Since the eye tracking device guides the light beam to the eye in no need of any additional optical component (such as the reflection mirrors mentioned in the Description of Related Art), the complexity of the optical components is reduced, the process yield is enhanced, and the size and the weight of the eye tracking device are reduced. Therefore, the eye tracking device and the HMD provided in one or more embodiments of the disclosure are light, thin and have a high process yield.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of an eye tracking device according to a first embodiment of the disclosure.

FIG. 2 is a schematic view of an eye tracking device according to a second embodiment of the disclosure.

FIG. 3 is a schematic view of an eye tracking device according to a third embodiment of the disclosure.

FIG. 4 is a schematic view of an eye tracking device according to a fourth embodiment of the disclosure.

FIG. 5 is a schematic view of an eye tracking device according to the fifth embodiment of the disclosure.

FIG. 6 is a schematic view of an HMD according to the first embodiment of the disclosure.

FIG. 7 is a schematic view of an HMD according to the second embodiment of the disclosure.

### DESCRIPTION OF THE EMBODIMENTS

The directional terms mentioned in the embodiments, such as “above”, “below”, “front”, “back”, “left”, and “right”, refer to the directions in the appended drawings. Therefore, the directional terms are only used for illustration instead of limiting the embodiments. In the drawings, the figures depict general features of methods, structures, and/or materials used in certain exemplary embodiments. However, these drawings should not be construed as defining or limiting the scope or nature of what is covered by these exemplary embodiments. For instance, the relative thicknesses and locations of various film layers, regions, and/or structures may be reduced or enlarged for clarity.

In the embodiments, the same reference numerals in the following description should be deemed as referring to the same or similar components when appearing in different drawings, and details may be omitted. In addition, features in different exemplary embodiments may be combined with each other as long as no conflict occurs, and simple equivalent changes and modifications made in accordance with the specification or the claims still fall within the scope of this disclosure. Besides, terms such as “first” and “second” as used in this specification or the claims are used to identify discrete components or to distinguish different embodiments or ranges, and are not intended to limit the upper limit or the lower limit of the number of components and are also not intended to limit the order of manufacture or the order of arrangement of the components.

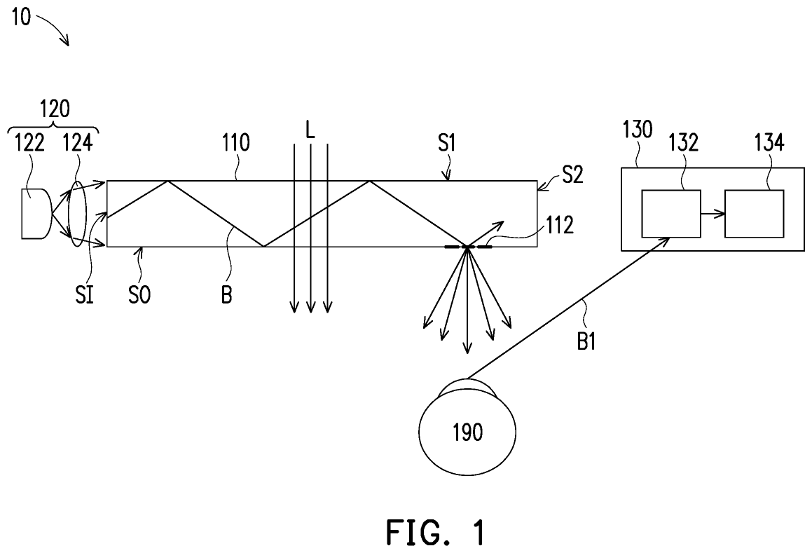

FIG. 1 is a schematic view of an eye tracking device 10 according to a first embodiment of the disclosure. With reference to FIG. 1, the eye tracking device 10 includes an optical waveguide component 110, a light source module 120, and an eye tracking module 130. The optical waveguide component 110 has a light-entrance surface SI and a light-exit surface SO connecting the light-entrance surface SI. The light-exit surface SO has a plurality of micro-structures 112 directly formed thereon. The light source module 120 is disposed next to the light-entrance surface SI and adapted to provide a light beam B. The light beam B enters the optical waveguide component 110 through the light-entrance surface SI, and the light beam B is emitted from the optical waveguide component 110 through the micro-structures 112 and is transmitted to the eye 190. The eye tracking module 130 receives a portion B1 of the light beam B reflected by the eye 190 and determines a location of the eye 190 according to the portion B1 of the light beam B reflected by the eye 190.

In detail, the optical waveguide component 110 receives the light beam B provided by the light source module 120 through the light-entrance surface SI and guides the light beam B to the location of the eye 190 according to the total internal reflection (TIR) principle. The light beam B is then output to the eye 190 by a plurality of micro-structures 112 directly formed on the light-exit surface SO. The fact that the micro-structures 112 directly formed on the light-exit surface SO means that the micro-structures 112 and the light-exit surface SO are bonded not through any other component or film layer (e.g., an adhesion layer). For instance, the micro-structures 112 may be formed through injection molding; that is, the micro-structures 112 and the optical waveguide component 110 may be integrally and simultaneously formed. Alternatively, the micro-structures 112 may be directly formed on the light-exit surface SO through imprinting or etching. That is to say, a main light guide body may be formed first, and then the micro-structures 112 may be formed on a surface of the main light guide body through imprinting or etching, so as to form the optical waveguide component 110.

Here, the micro-structures 112 may include, but are not limited to, a diffractive optical component pattern, a holographic optical component pattern, or a grating pattern. In addition, the optical waveguide component 110 may be a light guide plate. The light guide plate may be a glass plate, a plastic plate, or have a plate-like structure formed by curing a transparent optical adhesive, which should however not be construed as a limitation in the disclosure.

The optical waveguide component 110 may be a light transmissive component. As such, the eye 190 may receive an ambient light beam L coming from the rear of the optical waveguide component 110. In other words, a user may see an ambient image behind the optical waveguide component 110. Under said circumstances, the eye tracking device 10 may be installed in an HMD applying AR or MR technologies. Alternatively, the optical waveguide component 110 may be an opaque component. For instance, a reflective layer (e.g., a metal layer) may be formed on a surface S1 of the optical waveguide component 110 to shield the ambient light beam L coming from the rear of the optical waveguide component 110. In other words, the user does not see the ambient image behind the optical waveguide component 110. Under said circumstances, the eye tracking device 10 may be formed in an HMD applying VR technologies.

In the present embodiment, the micro-structures 112 are disposed on one portion of the light-exit surface SO. That is to say, the micro-structures 112 are not disposed on the other portion of the light-exit surface SO. Further, the micro-structures 112 are disposed on a side of the light-exit surface SO away from the light-entrance surface SI. In other words, the micro-structures 112 are closer to a surface S2 of the optical waveguide component 110 and are farther away from the light-entrance surface SI of the optical waveguide component 110. However, the location, the arrangement manner, the shape, and the size of the micro-structures 112 on the light-exit surface SO may be changed as required and are not limited to what is shown in FIG. 1. For instance, the micro-structures 112 may be recesses or protrusions on the optical waveguide component 110. In addition, each micro-structure 112 may have a bar shape or a block shape, and the micro-structures 112 may be arranged at equal intervals or specific intervals; each micro-structure 112 may have the same size, or the size of each micro-structure 112 complies with a certain rule. In addition, when the light-exit surface SO of the optical waveguide component 110 is a curved surface, the shape and the size of the micro-structures 112 and the interval between the micro-structures 112 may also be adjusted accordingly.

The light source module 120 may include a light-emitting component 122 and an optical component 124. FIG. 1 schematically illustrates that the light source module 120 includes one light-emitting component 122 and one optical component 124, but the types of components included in the light source module 120 and the number of components may be changed according to actual requirements and are not limited to what is illustrated in FIG. 1.

The light-emitting component 122 may be a non-visible light-emitting component or a visible light light-emitting component. The non-visible light-emitting component may be but is not limited to an infrared light-emitting component. For instance, the light-emitting component 122 may include a light-emitting diode (LED) or an organic light-emitting diode (OLED), which should however not be construed as a limitation in the disclosure.

The optical component 124 is disposed on the transmission path of the light beam B emitted by the light-emitting component 122 and between the light-emitting component 122 and the light-entrance surface SI of the optical waveguide component 110. The optical component 124 is adapted to converge the light beam B into the optical waveguide component 110. For instance, the optical component 124 may be a convex lens, which should however not be construed as a limitation in the disclosure.

The eye tracking module 130 may include a sensing module 132 and a processor 134. The sensing module 132 is adapted to receive the portion B1 of the light beam B reflected by the eye 190. For instance, the sensing module 132 may include a charge-coupled device (CCD) or a complementary metal-oxide semiconductor (CMOS) sensor. In some embodiments, the sensing module 132 is disposed corresponding to the micro-structures 112 to increase the light receiving rate of the sensing module 132. In some embodiments, the sensing module 132 is disposed away from the light-emitting component 122 of the light source module 120 to avoid interference and improve the recognition rate. For instance, the sensing module 132 may be disposed beside or close to the surface S2.

The processor 134 is coupled to the sensing module 132 to receive a signal associated with the portion B1 of the light beam B output by the sensing module 132 and determine an eye gaze direction of the eye 190 according to the signal; that is, the processor 134 determines the location of the eye 190 according to the portion B1 of the light beam B reflected by the eye 190. For instance, the processor 134 may include a microprocessor, a central processing unit (CPU), a graphics processing unit (GPU), or other integrated circuits.

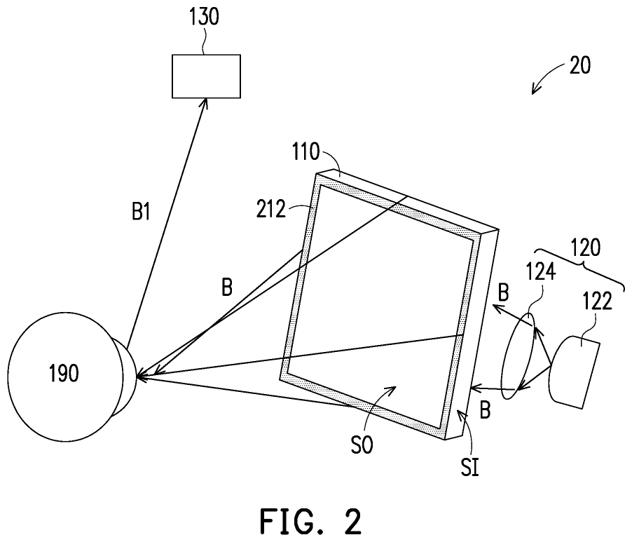

FIG. 2 is a schematic view of an eye tracking device 20 according to a second embodiment of the disclosure. With reference to FIG. 2, the main differences between the eye tracking device 20 and the eye tracking device 10 depicted in FIG. 1 are as follows. In the eye tracking device 20, a plurality of micro-structures 212 are successively disposed on an edge of the light-exit surface SO. In other words, the micro-structures 212 are disposed around the edge (at the peripheries) of the light-exit surface SO, and no micro-structure is disposed in the central portion of the light-exit surface SO.

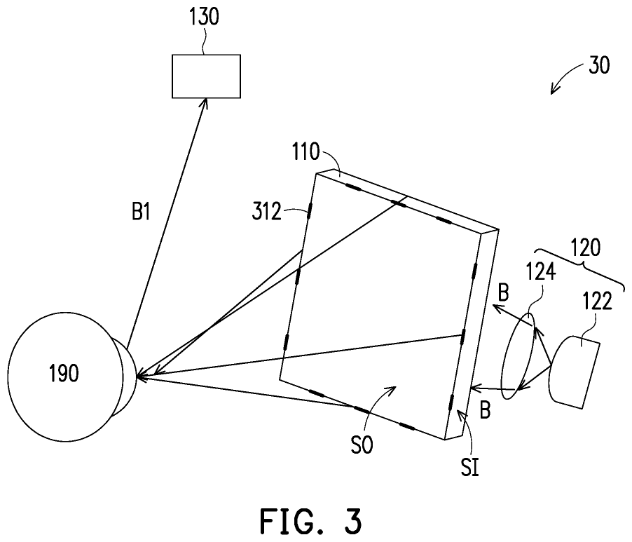

FIG. 3 is a schematic view of an eye tracking device 30 according to a third embodiment of the disclosure. With reference to FIG. 3, the eye tracking device 30 and the eye tracking device 10 depicted in FIG. 1 are in the eye tracking device 30, and a plurality of micro-structures 312 are intermittently disposed on the edge of the light-exit surface SO. For instance, the micro-structures 312 may be a plurality of dot micro-structures disposed at equal intervals or unequal intervals, which should however not be construed as a limitation in the disclosure.

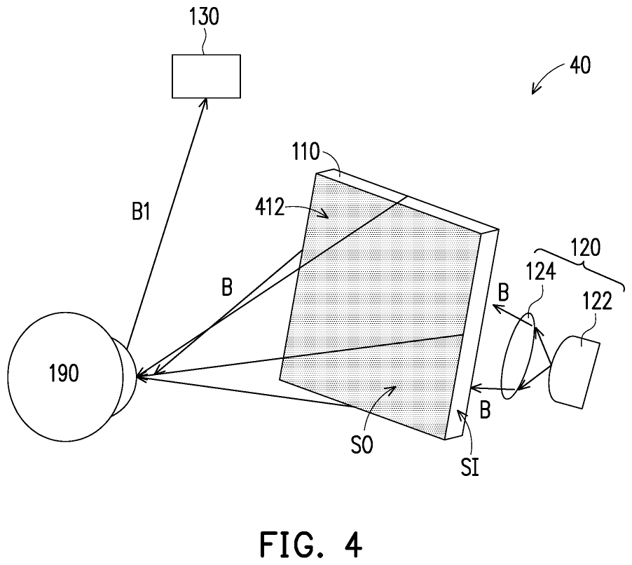

FIG. 4 is a schematic view of an eye tracking device 40 according to a fourth embodiment of the disclosure. With reference to FIG. 4, the main differences between the eye tracking device 40 and the eye tracking device 10 depicted in FIG. 1 are as follows. In the eye tracking device 40, a plurality of micro-structures 412 are disposed on the entire light-exit surface SO.

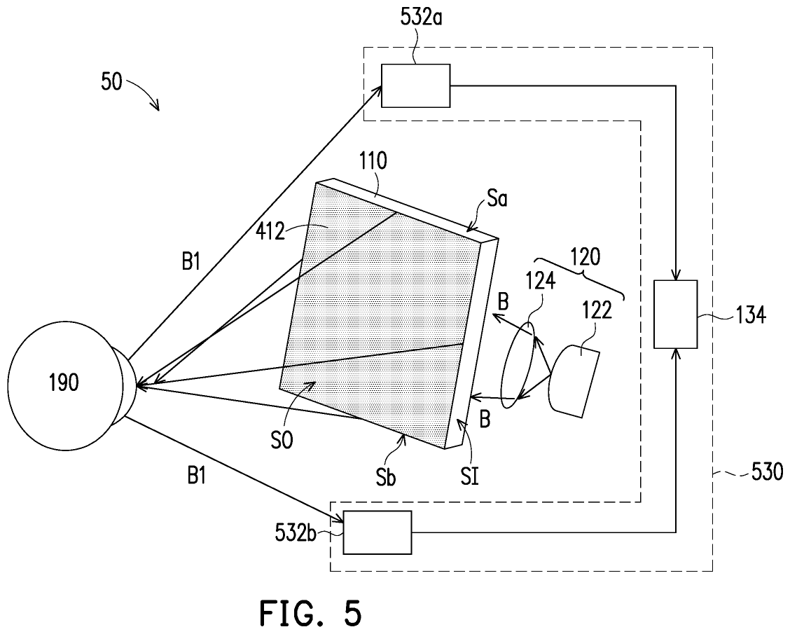

FIG. 5 is a schematic view of an eye tracking device 50 according to a fifth embodiment of the disclosure. With reference to FIG. 5, the main differences between the eye tracking device 50 and the eye tracking device 40 depicted in FIG. 4 are as follows. In the eye tracking device 50, the eye tracking module 530 includes a sensing module 532a and a sensing module 532b respectively coupled to the processor 134. The sensing module 532a and the sensing module 532b may be respectively disposed on different surfaces of the optical waveguide component 110 (such as the surface Sa and the surface Sb). The surface Sa and the surface Sb may be opposite surfaces that are not adjacent to each other, which should however not be construed as a limitation in the disclosure. In another embodiment, the eye tracking module 530 may include two or more sensing modules.

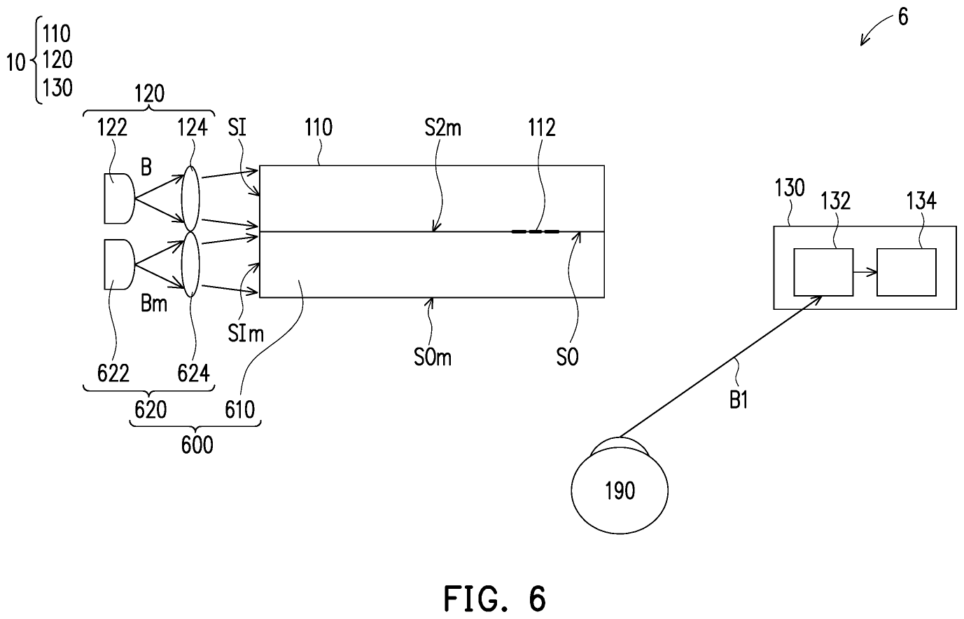

FIG. 6 is a schematic view of an HMD 6 according to the first embodiment of the disclosure. With reference to FIG. 6, the HMD 6 includes an image device 600 and an eye tracking device 10, wherein the image device 600 provides display information, and the eye tracking device 10 tracks the eye gaze. For instance, the image device 600 displays images with use of the visible light, and the eye tracking device 10 tracks the eye gaze with use of the non-visible light. That is, the light source module 120 includes a non-visible light source, which should however not be construed as a limitation in the disclosure. The description of the eye tracking device 10 is provided in the foregoing paragraphs and thus will not be repeated hereinafter. In other embodiments, the eye tracking device 10 may be replaced by the eye tracking device 20 depicted in FIG. 2, the eye tracking device 30 depicted in FIG. 3, the eye tracking device 40 depicted in FIG. 4, or the eye tracking device 50 depicted in FIG. 5.

The image device 600 includes an image optical waveguide component 610 and an image light source module 620. The image light source module 620 is adapted to provide an image beam Bm. For instance, the image light source module 620 may include a visible light source 622 and an optical component 624. However, the types and the number of components included in the image light source module 620 may be changed according to actual requirements and are not limited to what is illustrated in FIG. 6.

The visible light source 622 may emit the image beam Bm in the visible light band. For instance, the visible light source 622 may be a liquid crystal on silicon (LCOS) display, a digital light processing (DLP) display, a liquid crystal display (LCD), an OLED display, a micro LED display, or any other suitable display device.

The optical component 624 is disposed on the transmission path of the image beam Bm emitted by the visible light source 622 and between the visible light source 622 and the image optical waveguide component 610. The optical component 624 is adapted to converge the image beam Bm into the image optical waveguide component 610. For instance, the optical component 624 may be a convex lens, which should however not be construed as a limitation in the disclosure.

The image optical waveguide component 610 has a light-entrance surface SIm and a light-exit surface SOm connecting the light-entrance surface SIm. The image light source module 620 is disposed next to the light-entrance surface SIm of the optical waveguide component 610, the image beam Bm output by the image light source module 620 enters the image optical waveguide component 610 through the light-entrance surface SIm, and the image beam Bm is output from the image optical waveguide component 610 through the light-exit surface SOm and transmitted to the eye 190.

The image optical waveguide component 610 overlaps the optical waveguide component 110, and the relative location between the optical waveguide component 610 and the optical waveguide component 110 is fixed. For instance, the adhesion layer is not disposed between the optical waveguide component 610 and the optical waveguide component 110, and the optical waveguide component 610 and the optical waveguide component 110 are mechanically latched and fixed, which should however not be construed as a limitation in the disclosure.

In this embodiment, the optical waveguide component 610 is located between the optical waveguide component 110 and the eye 190 (for instance, the surface S2m of the optical waveguide component 610 opposite to the light-exit surface SOm is in contact with the light-exit surface SO of the optical waveguide component 110), and therefore the image optical waveguide component 610 is designed to allow light beams (e.g., non-visible light beam beams) that are emitted from the optical waveguide component 110 through the micro-structures 112 to pass through, such that the light beams emitted from the optical waveguide component 110 through the micro-structures 112 may be transmitted to the eye 190 after passing through the optical waveguide component 610.

FIG. 6 schematically shows an image device (the image device 600) and an eye tracking device (the eye tracking device 10) provided corresponding to a single eye (the eye 190) of the user. However, in another embodiment, the HMD 6 may further include another image device provided corresponding to the other eye of the user and another eye tracking device. In addition, the two eye tracking devices may share one eye tracking module (including the sensing module and the processors) or respectively use different eye tracking modules. Alternatively, the two eye tracking devices may use different sensing modules but share a single processor. The above description is also applicable in the following embodiment and thus will not be repeated hereinafter.

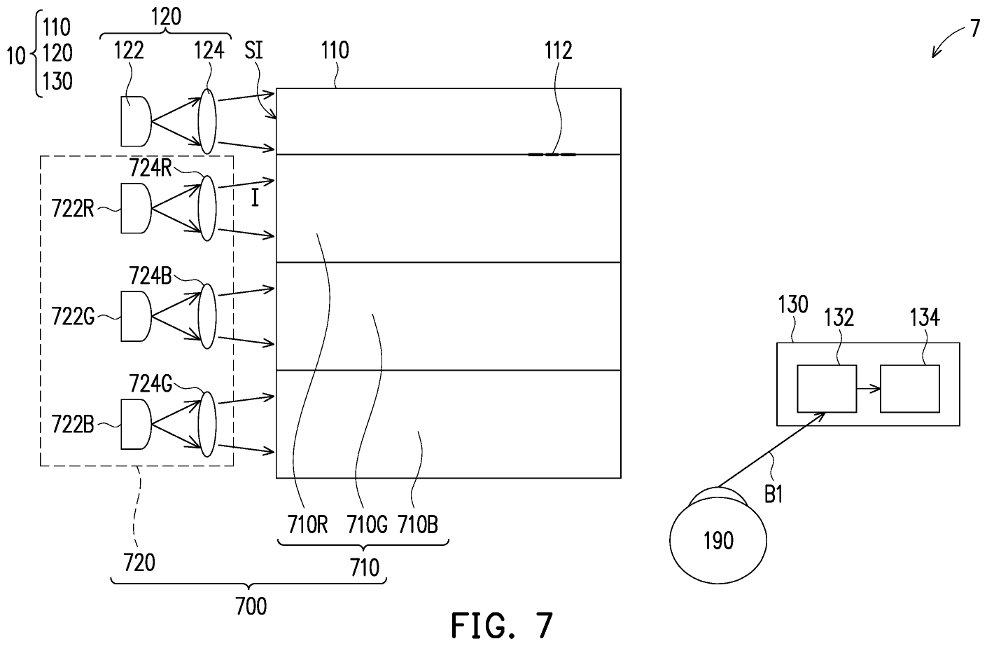

FIG. 7 is a schematic view of an HMD 7 according to the second embodiment of the disclosure. As shown in FIG. 7, the main differences between the HMD 7 and the HMD 6 depicted in FIG. 6 are as follows. The HMD 7 includes an image device 700 and an eye tracking device 10. In the image device 700, the image optical waveguide component 710 includes three overlapping visible optical waveguide components 710R, 710G, and 710B. The relative locations of the visible optical waveguide components 710R, 710G, 710B and the optical waveguide component 110 is fixed. For instance, no adhesion layer is disposed between the visible optical waveguide components 710R, 710G, 710B and the optical waveguide component 110, and the visible optical waveguide components 710R, 710G, 710B and the optical waveguide component 110 may be mechanically latched and fixed, which should however not be construed as a limitation in the disclosure.

In addition, the image light source module 720 includes visible light sources 722R, 722G, 722B and optical components 724R, 724G, 724B. The visible light sources 722R, 722G, and 722B provide a red light beam, a green light beam, and a blue light beam, respectively. The optical component 724R is disposed on the transmission path of the red light beam emitted by the visible light source 722R and between the visible light source 722R and the visible optical waveguide component 710R. The optical component 724G is disposed on the transmission path of the green light beam emitted by the visible light source 722G and between the visible light source 722G and the visible optical waveguide component 710G. The optical component 724B is disposed on the transmission path of the blue light beam emitted by the visible light source 722B and between the visible light source 722B and the visible optical waveguide component 710B. In other embodiments, the number of visible optical waveguide components included in the image optical waveguide component 710, the types of colors of the visible light sources included in the image light source module 720, and the number of the visible light sources may be changed according to actual requirements and are not limited to what is shown in FIG. 7.

To sum up, in the eye tracking device and the HMD provided in one or more embodiments of the disclosure, the optical waveguide component has the micro-structures directly formed thereon, and the optical waveguide component guides the light beam to the eye through the micro-structures directly formed thereon, so that the eye tracking device may guide the light beam to the eye in no need of any additional optical component (such as a plurality of mirrors mentioned in the Description of Related Art). Accordingly, in addition to reducing the complexity of the optical components and improving the process yield, the volume and the weight of the eye tracking device may be reduced. As a result, the eye tracking device and the HMD provided in one or more embodiments of the disclosure are light, thin, and have a high process yield.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An eye tracking device comprising:
an optical waveguide component having a light-entrance surface and a light-exit surface connecting the light-entrance surface, the light-exit surface having a plurality of micro-structures directly formed on the light-exit surface;
a light source module disposed next to the light-entrance surface and adapted to provide a light beam, wherein the light beam enters the optical waveguide component through the light-entrance surface, and the light beam is emitted from the optical waveguide component through the micro-structures and is transmitted to an eye; and
an eye tracking module receiving a portion of the light beam reflected by the eye and determining a location of the eye according to the portion of the light beam reflected by the eye.

2. The eye tracking device according to claim 1, wherein the micro-structures comprise a diffractive optical component pattern, a holographic optical component pattern, or a grating pattern.

3. The eye tracking device according to claim 1, wherein the micro-structures are disposed on a side of the light-exit surface away from the light-entrance surface.

4. The eye tracking device according to claim 1, wherein the micro-structures are successively disposed on an edge of the light-exit surface.

5. The eye tracking device according to claim 1, wherein the micro-structures are intermittently disposed on an edge of the light-exit surface.

6. The eye tracking device according to claim 1, wherein the micro-structures are disposed on the entire light-exit surface.

7. The eye tracking device according to claim 1, wherein the eye tracking module comprises:
at least one sensing module receiving a portion of the light beam reflected by the eye; and
a processor determining the location of the eye according to the portion of the light beam reflected by the eye.

8. A head mounted display comprising:
an image device comprising:
an image optical waveguide component having a light-entrance surface and a light-exit surface connecting the light-entrance surface; and
an image light source module disposed next to the light-entrance surface of the optical waveguide component and adapted to provide an image beam; and
an eye tracking device comprising:
an optical waveguide component overlapping the optical waveguide component, wherein the optical waveguide component has a light-entrance surface and a light-exit surface connecting the light-entrance surface, and the light-exit surface of the optical waveguide component has a plurality of micro-structures directly formed on the light-exit surface of the optical waveguide component;
a light source module disposed next to the light-entrance surface of the optical waveguide component and adapted to provide a light beam, wherein the light beam enters the optical waveguide component through the light-entrance surface of the optical waveguide component, and the light beam is emitted from the optical waveguide component through the micro-structures and is transmitted to an eye; and
an eye tracking module receiving a portion of the light beam reflected by the eye and determining a location of the eye according to the portion of the light beam reflected by the eye.

9. The head mounted display according to claim 8, wherein the image optical waveguide component comprises one visible optical waveguide component or a plurality of overlapping visible optical waveguide components, the image light source module comprises at least one visible light source corresponding to the visible optical waveguide component or the plurality of overlapping visible optical waveguide components, and the light source module comprises a non-visible light source.

10. The head mounted display according to claim 8, wherein no adhesion layer is disposed between the image optical waveguide component and the optical waveguide component.
